(19) United States
(12) Patent Application Publication
(10) Pub. No.: US 2026/0023294 A1
(43) Pub. Date: Jan. 22, 2026

(54) Array Substrate, Display Panel and Display Apparatus

(71) Applicants: Beijing BOE CHUANGYUAN Technology Co., Ltd., Beijng (CN); BOE Technology Group Co., LTD, Chaoyang District, Beijing (CN)

(72) Inventors: Deshuai Wang, Beijing (CN); Ning Wang, Beijing (CN); Jianyun Xie, Beijing (CN); Jian Sun, Beijing (CN); Zhen Wang, Beijing (CN); Wenwen Qin, Beijing (CN); Jiantao Liu, Beijing (CN)

(21) Appl. No.: 18/865,741

(22) PCT Filed: Dec. 22, 2023
(86) PCT No.: PCT/CN2023/141254

§ 371 Date: Nov. 14, 2024

(51) Int. Cl. G02F 1/1368; G02F 1/1362

(52) U.S. Cl. CPC G02F 1/1368; G02F 1/136209; G02F 1/136222; G02F 1/13629

(57) ABSTRACT

An array substrate includes sub-pixels located in a display area of the array substrate. Each sub-pixel includes a first transistor and a pixel electrode. The array substrate includes a base substrate; a first gate metal layer, a first source-drain metal layer, a planarization layer and a pixel electrode layer that are sequentially arranged on the base substrate; and first light-blocking patterns located on a side of the first gate metal layer away from the base substrate. The first source-drain metal layer includes a drain pattern of the first transistor. The pixel electrode layer includes pixel electrodes. A pixel electrode and a drain pattern of a first transistor belonging to a same sub-pixel are connected through a first via hole in the planarization layer. An orthographic projection of the first via hole on the base substrate is located within an orthographic projection of a first light-blocking pattern on the base substrate.

### CROSS-REFERENCE TO RELATED APPLICATION

This application is the United States national phase of International Patent Application No. PCT/CN2023/141254, filed Dec. 22, 2023, the disclosure of which is hereby incorporated by reference in its entirety.

### BACKGROUND OF THE INVENTION

### Field of the Invention

The present disclosure relates to the field of display technologies, and in particular, to an array substrate, a display panel and a display apparatus.

### Description of Related Art

Liquid crystal display (LCD) apparatuses have been widely applied in the display field due to advantages such as small size, low power consumption, light and thin, and no radiation. With the development of display technology, the display quality has been continuously improved with the progress of manufacturing technology.

### SUMMARY OF THE INVENTION

In an aspect, an array substrate is provided. The array substrate has a display area and a peripheral area disposed on a periphery of the display area. The array substrate includes a plurality of sub-pixels located in the display area, and each sub-pixel of the plurality of sub-pixels includes a first transistor and a pixel electrode. The array substrate includes a base substrate, a first gate metal layer, a first source-drain metal layer, a planarization layer and a pixel electrode layer. The first gate metal layer is disposed on a side of the base substrate; the first source-drain metal layer is disposed on a side of the first gate metal layer away from the base substrate, and the first source-drain metal layer includes a drain pattern of the first transistor; the planarization layer is disposed on a side of the first source-drain metal layer away from the base substrate, and the planarization layer has first via holes; the pixel electrode layer is disposed on a side of the planarization layer away from the base substrate, the pixel electrode layer includes a plurality of pixel electrodes, and a pixel electrode and a drain pattern of a first transistor belonging to a same sub-pixel are connected through a first via hole of the first via holes.

The array substrate further includes first light-blocking patterns located on a side of the first gate metal layer away from the base substrate, and an orthographic projection of the first via hole on the base substrate is located within an orthographic projection of a first light-blocking pattern of the first light-blocking patterns on the base substrate.

In some embodiments, the sub-pixel further includes a color resist block, and the array substrate further includes a color resist layer disposed between the first source-drain metal layer and the planarization layer; the color resist layer includes a plurality of color resist blocks, and a color resist block and the pixel electrode belonging to the same sub-pixel overlap; color resist blocks of two adjacent sub-pixels in a first direction have a gap region therebetween; the first via hole is located in the gap region; the first direction is a column direction in which the plurality of sub-pixels are arranged in an array. A dimension of the first light-blocking pattern in the first direction is greater than or equal to a dimension of the gap region in the first direction.

In some embodiments, the array substrate further includes a first active film layer disposed between the first gate metal layer and the first source-drain metal layer; the first active film layer includes an active pattern of the first transistor included in each sub-pixel. The first gate metal layer includes first gate lines, and a first gate line overlaps with active patterns of first transistors of a row of sub-pixels. A dimension of the first gate line in the first direction is less than the dimension of the first light-blocking pattern in the first direction.

In some embodiments, the array substrate further includes a passivation layer, a common signal line layer and a common electrode layer that are sequentially arranged on a side of the pixel electrode layer away from the base substrate, and the first light-blocking patterns are located in the common signal line layer.

In some embodiments, the common signal line layer includes a plurality of common signal lines extending in a first direction; the array substrate further includes a color resist layer disposed between the first source-drain metal layer and the planarization layer, the color resist layer includes a plurality of color resist blocks, and orthographic projections of boundaries of two columns of color resist blocks adjacent to a common signal line on the base substrate are located in an orthographic projection of the common signal line on the base substrate.

In some embodiments, the common signal line layer includes a plurality of common signal lines connected to the common electrode layer and configured to transmit a common voltage signal to the common electrode layer.

In some embodiments, the common signal line layer includes a plurality of first light-blocking lines extending in a second direction; the second direction is a row direction in which the plurality of sub-pixels are arranged in an array; orthographic projections of first via holes of a row of sub-pixels on the base substrate are located within an orthographic projection of a first light-blocking line of the plurality of first light-blocking lines on the base substrate; and the first light-blocking line includes multiple first light-blocking patterns.

In some embodiments, the array substrate further includes a color resist layer disposed between the first source-drain metal layer and the planarization layer, the color resist layer includes a plurality of color resist blocks, and the orthographic projection of the first light-blocking line on the base substrate is located between orthographic projections of two adjacent rows of color resist blocks on the base substrate.

In some embodiments, the first gate metal layer includes first gate lines, and an orthographic projection of a channel region of an active pattern of the first transistor on the base substrate is located within an orthographic projection of a first gate line on the base substrate.

In some embodiments, the array substrate further includes a first active film layer disposed between the first gate metal layer and the first source-drain metal layer, and a second gate metal layer disposed between the first active film layer and the first source-drain metal layer; the first light-blocking patterns are located in the second gate metal layer.

In some embodiments, the second gate metal layer includes second gate lines, and a second gate line overlaps with active patterns of first transistors of a row of sub-pixels; in the same sub-pixel, an active pattern of the first transistor overlaps with the first via hole, and the first light-blocking pattern is a portion of the second gate line overlapping with the active pattern of the first transistor.

In some embodiments, the first gate metal layer includes first gate lines, and a portion of a first gate line overlapping with an active layer of the first transistor serves as a gate pattern of the first transistor.

In some embodiments, the second gate line and the first gate line are electrically connected in the peripheral area, and a portion of the second gate line overlapping with the active pattern of the first transistor serves as a top gate pattern of the first transistor.

In some embodiments, the second gate metal layer includes second gate lines, and a second gate line overlaps with active patterns of first transistors of a row of sub-pixels; the second gate line includes a first light-blocking pattern and a second gate pattern that are connected, the second gate pattern overlaps with an active pattern of the first transistor, and the second gate pattern serves as a gate pattern of the first transistor; the first light-blocking patterns is non-overlapping with the active pattern of the first transistor.

In some embodiments, the array substrate further includes a second source-drain metal layer disposed between the first source-drain metal layer and the second gate metal layer; the second source-drain metal layer includes data lines extending in a first direction, and an orthographic projection of a data line on the base substrate overlaps with an orthographic projection of the second gate pattern on the base substrate. The first direction is a column direction in which the plurality of sub-pixels are arranged.

In some embodiments, the array substrate further includes a second transistor disposed in the peripheral area, and a gate pattern of the second transistor is located in the first gate metal layer. The array substrate further includes: a second active film layer disposed between the base substrate and the first gate metal layer, and a second source-drain metal layer disposed on a side of the first source-drain metal layer proximate to the base substrate. The second active film layer includes an active pattern of the second transistor, and the second source-drain metal layer includes a source pattern and a drain pattern of the second transistor and a source pattern of the first transistor.

In another aspect, a display panel is provided, which includes the array substrate as described in the above, an opposite substrate arranged opposite to the array substrate, and a liquid crystal layer located between the array substrate and the opposite substrate.

In some embodiments, the display panel further includes a first boss and a second boss that are disposed between the array substrate and the opposite substrate; the first boss is disposed closer to the array substrate than the second boss, and the first boss and the second boss are arranged opposite to each other. An orthographic projection of the first boss on the base substrate is located within the orthographic projection of the first light-blocking pattern on the base substrate.

In some embodiments, the opposite substrate includes a black matrix light-blocking pattern, and the orthographic projection of the first light-blocking pattern on the base substrate is located within an orthographic projection of the black matrix light-blocking pattern on the base substrate.

In yet another aspect, a display apparatus is provided, which includes the display panel as described in the above and a backlight module stacked with the display panel.

### BRIEF DESCRIPTION OF THE DRAWINGS

In order to describe the technical solutions in the present disclosure more clearly, the accompanying drawings to be used in some embodiments of the present disclosure will be briefly introduced below. Obviously, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1A is a sectional view of a display panel, in accordance with some examples;

FIG. 1B is a diagram showing the dimensional relationship between a first via hole and a first gate pattern, in accordance with some examples;

FIG. 2A is a sectional view of a display panel, in accordance with some embodiments of the present disclosure;

FIG. 2B is a diagram showing the dimensional relationship between a first via hole and a first light-blocking pattern, in accordance with some embodiments of the present disclosure;

FIG. 3A is a film layer structural diagram of a first gate metal layer of an array substrate, in accordance with some embodiments of the present disclosure;

FIG. 3B is a diagram showing a stacked structure of film layers including a first active film layer of an array substrate, in accordance with some embodiments of the present disclosure;

FIG. 3C is a diagram showing a stacked structure of film layers including a second gate metal layer of an array substrate, in accordance with some embodiments of the present disclosure;

FIG. 3D is a diagram showing a stacked structure of film layers including a second interlayer dielectric layer of an array substrate, in accordance with some embodiments of the present disclosure;

FIG. 3E is a diagram showing a stacked structure of film layers including a second source-drain metal layer of an array substrate, in accordance with some embodiments of the present disclosure;

FIG. 3F is a diagram showing a stacked structure of film layers including a first source-drain metal layer of an array substrate, in accordance with some embodiments of the present disclosure;

FIG. 3G is a diagram showing a stacked structure of film layers including a color resist layer of an array substrate, in accordance with some embodiments of the present disclosure;

FIG. 3H is a diagram showing a stacked structure of film layers including a planarization layer of an array substrate, in accordance with some embodiments of the present disclosure;

FIG. 3I is a diagram showing a stacked structure of film layers including a pixel electrode layer of an array substrate, in accordance with some embodiments of the present disclosure;

FIG. 3J is a diagram showing a stacked structure of film layers including a common signal line layer of an array substrate, in accordance with some embodiments of the present disclosure;

FIG. 4A is a sectional vie of another display panel, in accordance with some other embodiments of the present disclosure;

FIG. 4B is a diagram showing a stacked structure of film layers of an array substrate, in accordance with some embodiments of the present disclosure;

FIG. 4C is a film layer structural diagram of a common signal line layer of an array substrate, in accordance with some embodiments of the present disclosure;

FIG. 5A is a sectional view of yet another display panel, in accordance with yet some other embodiments of the present disclosure;

FIG. 5B is a sectional view of yet another display panel, in accordance with still yet some other embodiments of the present disclosure;

FIG. 6A is a diagram showing a stacked structure of film layers of a first gate metal layer and a first active film layer of an array substrate, in accordance with some embodiments of the present disclosure;

FIG. 6B is a diagram showing a stacked structure of film layers of a first active film layer and a second gate metal layer of an array substrate, in accordance with some embodiments of the present disclosure;

FIG. 6C is a diagram showing a stacked structure of film layers of a first active film layer\first gate metal layer and a second gate metal layer of an array substrate, in accordance with some embodiments of the present disclosure;

FIG. 6D is a diagram showing a stacked structure of film layers of an array substrate, in accordance with some other embodiments of the present disclosure;

FIG. 6E is a diagram showing a stacked structure of film layers of another array substrate, in accordance with yet some other embodiments of the present disclosure;

FIG. 7 is a plan view of an array substrate, in accordance with some embodiments of the present disclosure;

FIG. 8 is a structural diagram of a display panel, in accordance with some embodiments of the present disclosure;

FIG. 9 is a sectional view of a display panel, in accordance with some other embodiments of the present disclosure; and

FIG. 10 is a sectional view of another display apparatus, in accordance with some embodiments of the present disclosure.

### DESCRIPTION OF THE INVENTION

The technical solutions in some embodiments of the present disclosure will be clearly and completely described below in conjunction with the accompanying drawings. Obviously, the embodiments to be described are merely some but not all embodiments of the present disclosure. All other embodiments obtained by a person of ordinary skill in the art based on the embodiments of the present disclosure should all belong to the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment”, “some embodiments”, “exemplary embodiments”, “example”, “specific example”, or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Thus, a feature defined with “first” or “second” may explicitly or implicitly include one or more of the feature. In the description of the embodiments of the present disclosure, the term “a/the plurality of” means two or more unless otherwise specified.

In the description of some embodiments, the terms “coupled”, “connected”, and derivatives thereof may be used. The term “connected” should be understood in a broad sense. For example, the term “connected” may represent a fixed connection, a detachable connection, or a one-piece connection; it may represent a direct connection, or an indirect connection through an intermediate medium. The term “coupled” may indicate that two or more components are in direct physical or electrical contact with each other. The term “coupled” or “communicatively coupled” may also indicate that two or more components are not in direct contact with each other but still cooperate or interact with each other. The embodiments disclosed herein are not necessarily limited to the content herein.

The phrase “at least one of A, B, and C” has the same meaning as the phrase “at least one of A, B, or C”, both including the following combinations of A, B, and C: only A, only B, only C, a combination of A and B, a combination of A and C, a combination of B and C, and a combination of A, B, and C.

The phrase “A and/or B” includes following three combinations: only A, only B, and a combination of A and B.

As used herein, the term “if” is, optionally, construed as “when” or “in a case where” or “in response to determining that” or “in response to detecting”, depending on the context. Similarly, depending on the context, the phrase “if it is determined that” or “if [a stated condition or event] is detected” is optionally construed as “in a case where it is determined that” or “in response to determining that” or “in a case where [the stated condition or event] is detected” or “in response to detecting [the stated condition or event]”.

The use of the phrase “applicable to” or “configured to” herein means an open and inclusive expression, which does not exclude devices that are applicable to or configured to perform additional tasks or steps.

In additional, the phase “based on” used herein is meant to be open and inclusive, since a process, step, calculation, or other action “based on” one or more of the stated conditions or values may, in practice, be based on additional conditions or values beyond those stated.

The term such as “about”, “substantially”, or “approximately” as used herein includes a stated value and an average value within an acceptable range of deviation of a particular value. The acceptable range of deviation is determined, for example, by a person of ordinary skill in the art, considering measurement in question and errors (i.e., limitations of a measurement system) associated with measurement of a particular quantity.

The term such as “parallel”, “perpendicular”, or “equal” as used herein includes a stated condition and a condition similar to the stated condition. A range of the similar condition is within an acceptable range of deviation, and the acceptable range of deviation is determined, for example, by a person of ordinary skill in the art, considering measurement in question and errors (i.e., the limitations of a measurement system) associated with measurement of a particular quantity. For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°, the term “equal” includes absolute equality and approximate equality, and an acceptable range of deviation of the approximate equality may be, for example, a difference between two equals is less than or equal to 5% of either of the two equals.

It will be understood that, in a case where a layer or element is referred to as being on another layer or substrate, it may be that the layer or element is directly on the another layer or substrate, or it may be that intervening layer(s) exist between the layer or element and the another layer or substrate.

Exemplary embodiments are described herein with reference to sectional views and/or plan views as idealized exemplary drawings. In the accompanying drawings, thicknesses of layers and areas of regions are enlarged for clarity. Thus, variations in shape with respect to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown to have a rectangular shape generally has a curved feature. Therefore, the regions shown in the accompanying drawings are schematic in nature, and their shapes are not intended to show actual shapes of the regions in an apparatus, and are not intended to limit the scope of the exemplary embodiments.

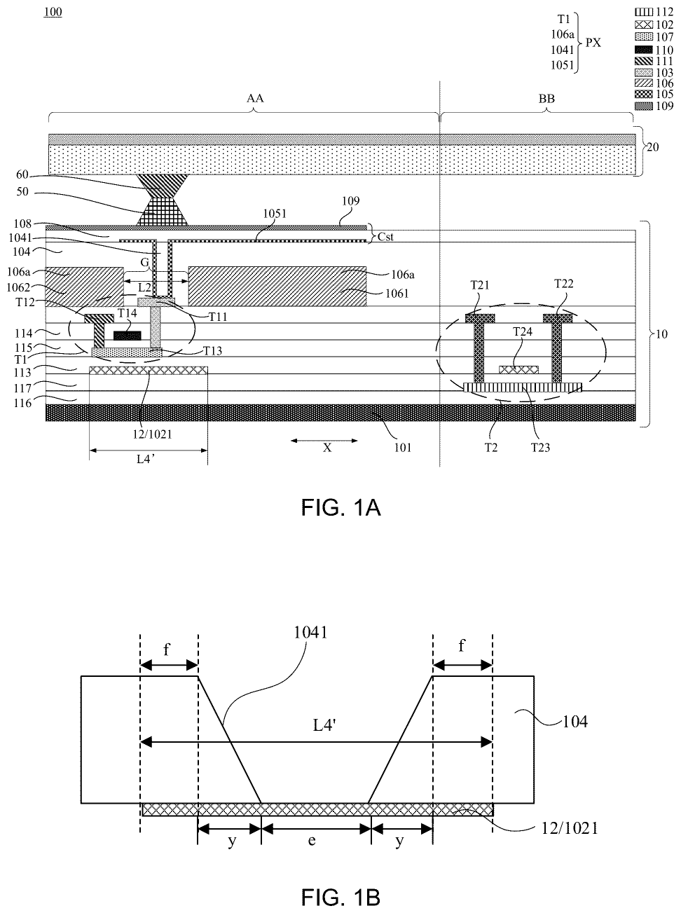

At present, in order to achieve high pixels-per-inch (PPI), a low-temperature polycrystalline oxide (LTPO) process is generally adopted to fabricate thin film transistors for display panels; that is, oxide thin film transistors are employed in a pixel area, and low-temperature polycrystalline silicon (LTPS) thin film transistors are employed in a peripheral area. As shown in FIG. 1A, in some examples, an array substrate is provided. The array substrate 10 has a display area AA and a peripheral area BB disposed on the periphery of the display area. The array substrate 10 includes a first transistor T1 located in the display area AA and a second transistor T2 located in the peripheral area BB. The first transistor T1 is, for example, an oxide thin film transistor, and the second transistor T2 is, for example, a low-temperature polycrystalline silicon thin film transistor. Patterns, in a same film layer, of the first transistor T1 and the second transistor T2 may be formed simultaneously.

The display panel includes a first gate metal layer 102, the first gate metal layer 102 includes: a gate pattern T24 of the second transistor T2 disposed in the peripheral area of the display panel, and a first gate pattern 12 disposed in the display area. The first gate pattern 12 overlaps with the first transistor T1, and in FIG. 1A, the first gate pattern 12 serves as a light-blocking bar 1021, and the light-blocking bar is used to block light to prevent the characteristics of the oxide thin film transistor from being affected by light, while avoiding other problems such as light leakage.

In some examples, during the fabricating process of the first gate metal layer, a photoresist is used as a mask to pattern an initial first gate metal layer to obtain the light-blocking bar 1021; in order to meet the above light-blocking requirement, the width of the light-blocking bar needs to be relatively great. For example, the dimension of the light-blocking bar 1021 (the first gate pattern 12) in the first direction X is L4′, thereby increasing the coverage rate of the photoresist. During fabricating the second transistor in the peripheral area, in order to simplify the fabricating process, the photoresist mask pattern used in fabricating the first gate metal layer is used to perform a doping process, such as an N+ doping process, on the active film layer of the second transistor. Since the coverage rate of the photoresist is relatively high, during the doping process, particles will bombard the surface of the photoresist and react with the photoresist to have a carbonization reaction, where a large amount of gas will be produced as a by-product. Therefore, high coverage rate of the photoresist will result in a large amount of gas overflowing from the photoresist, which affects the vacuum degree in the chamber and makes it easier for a vacuum alarm to occur.

Based on this, in some embodiments of the present disclosure, by arranging the film layers in the array substrate in layers and reasonably arranging the position of the light-blocking bar, it is possible to reduce the width of the light-blocking bar while the above light-blocking requirement is ensured, so as to prevent equipment alarms from occurring during the fabricating process to improve the reliability of the display panel.

The array substrate, display panel and display apparatus provided by some embodiments of the present disclosure will be individually introduced below.

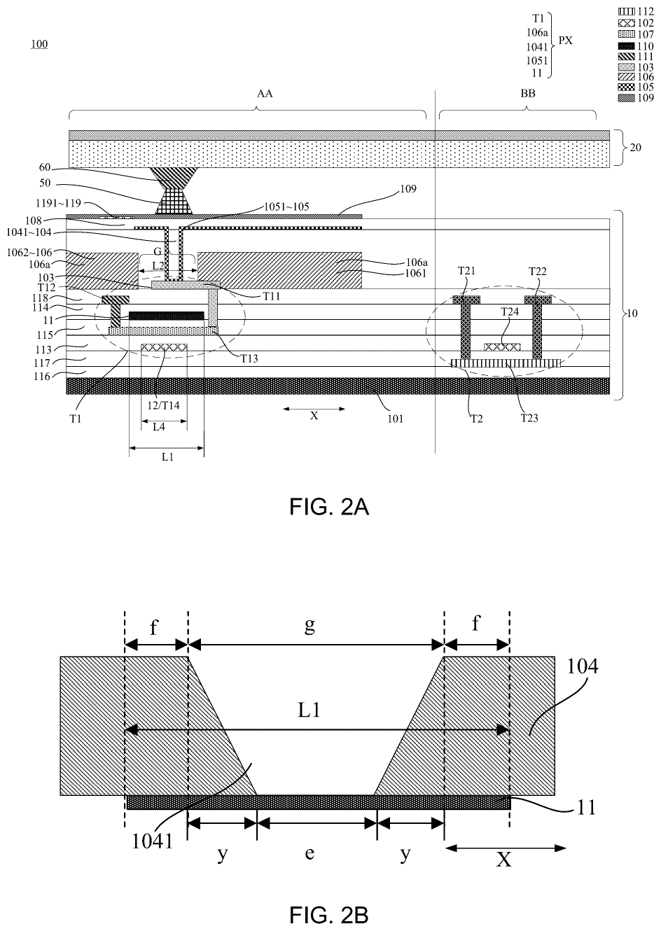

As shown in FIGS. 2A, 4A, 5A, 5B and 9, multiple embodiments of an array substrate are provided in the present disclosure. In order to clearly describe the film layer structure of the array substrate, all the film layers included in the array substrate are listed below. The array substrate 10 includes a base substrate 101, and a buffer layer 116, a second active film layer 112, a first gate insulating layer 117, a first gate metal layer 102, a first interlayer dielectric layer 113, a first active film layer 107, a second gate insulating layer 115, a second gate metal layer 110, a second interlayer dielectric layer 114, a second source-drain metal layer 111, an interlayer insulating layer 118, a first source-drain metal layer 103, a color resist layer 106, a planarization layer 104, a pixel electrode layer 105, a passivation layer 108, a common signal line layer 119 and a common electrode layer 109 that are sequentially arranged on the base substrate 101.

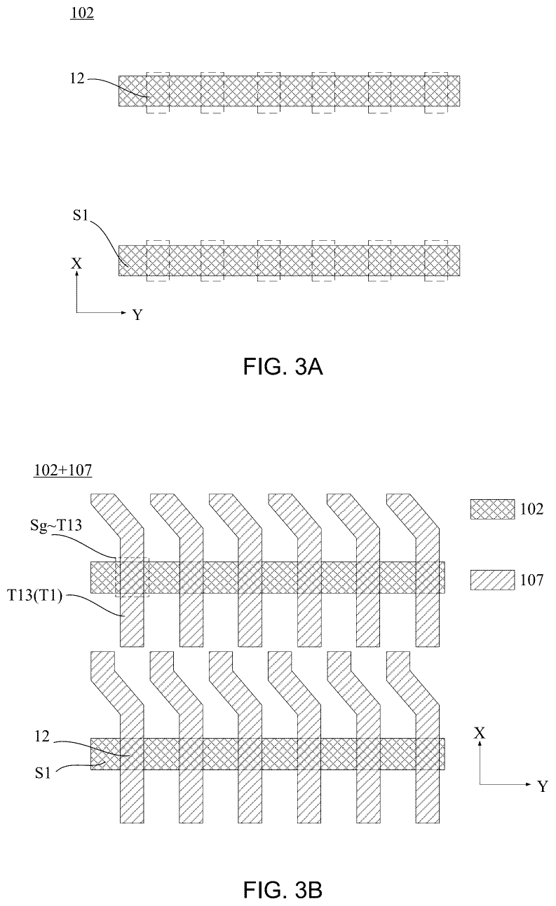

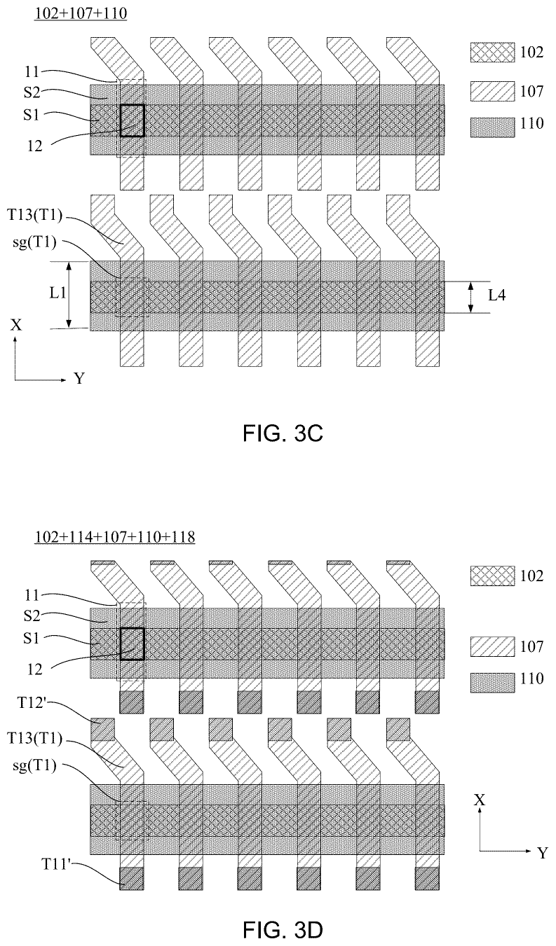

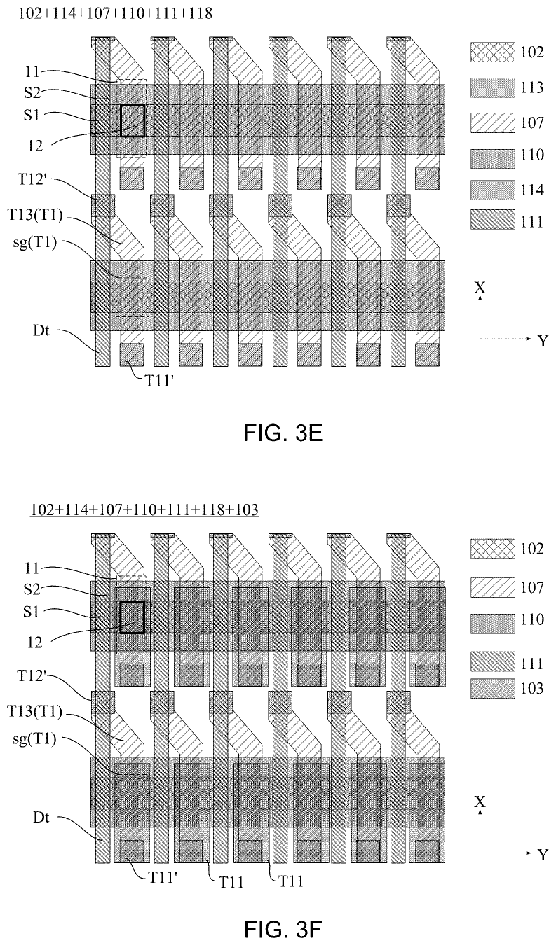

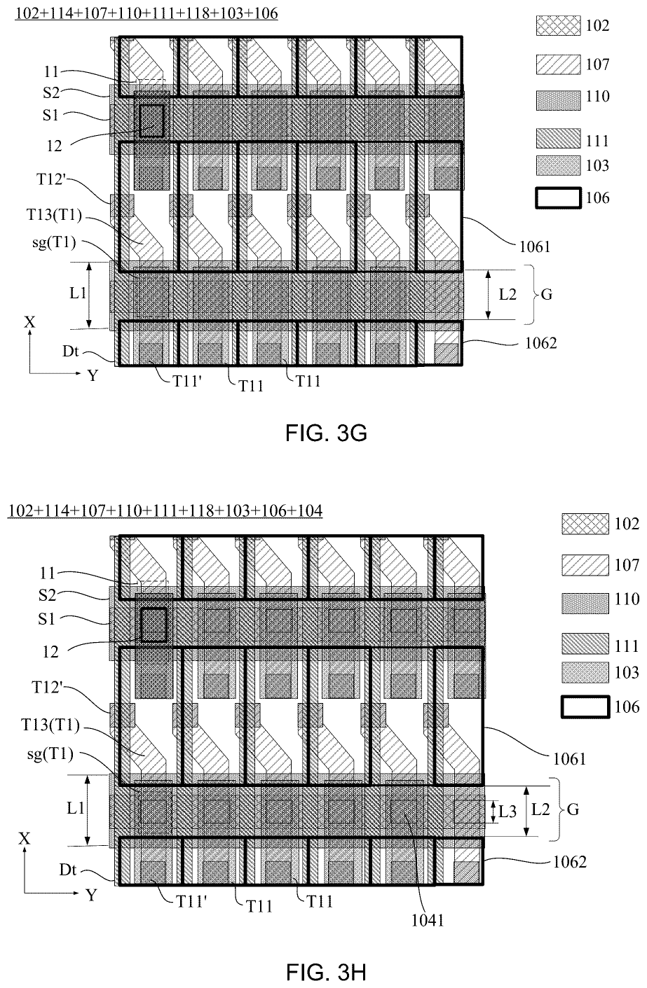

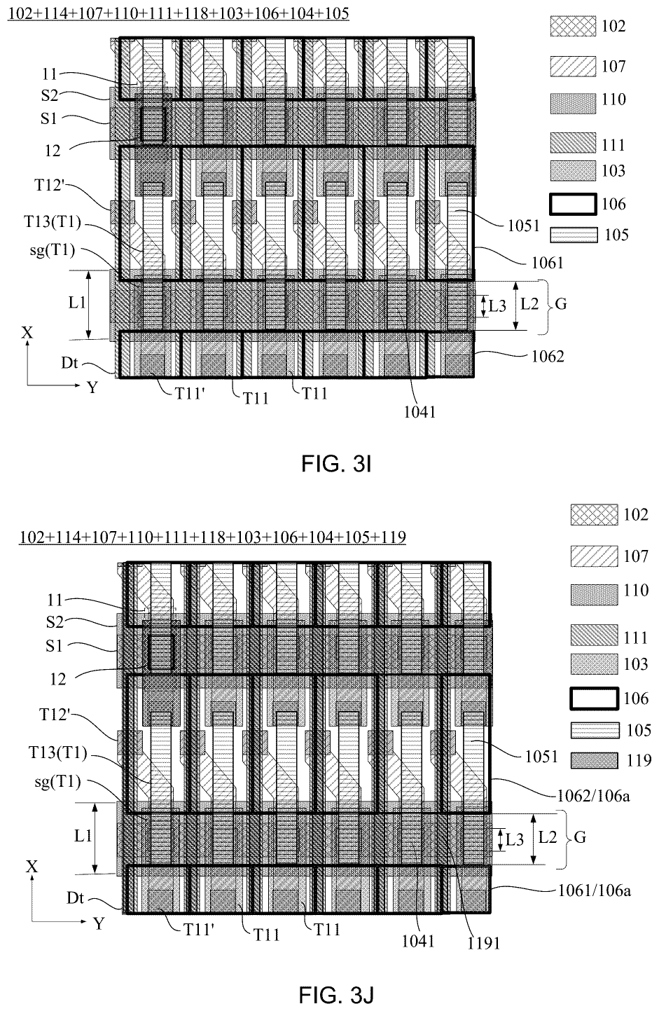

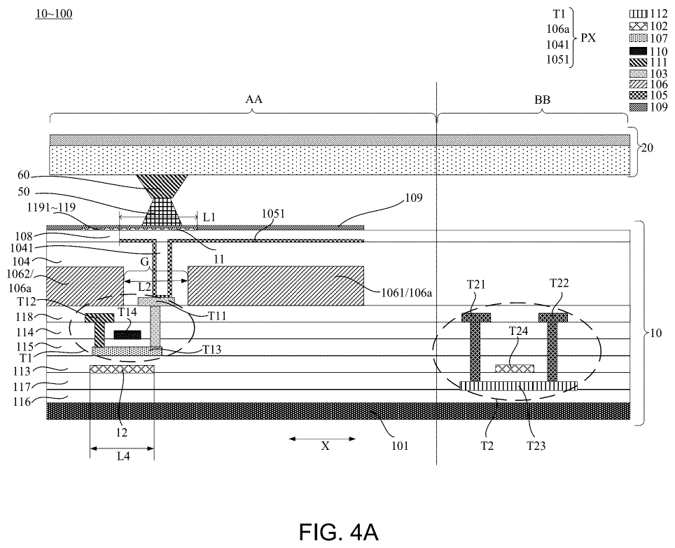

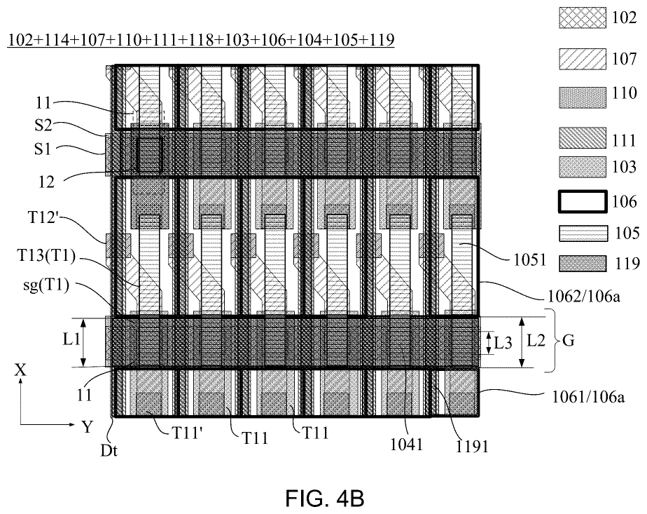

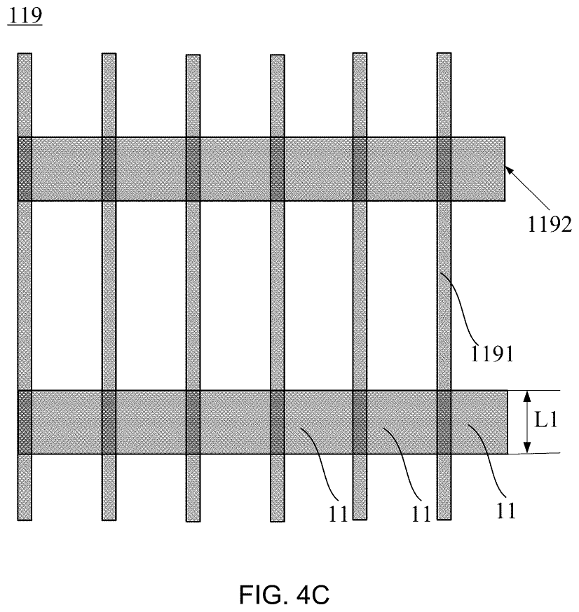

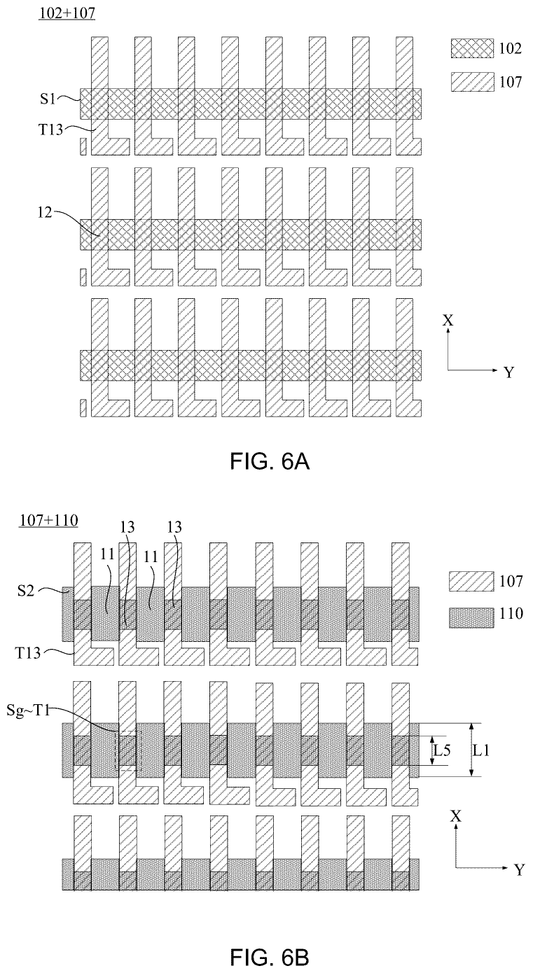

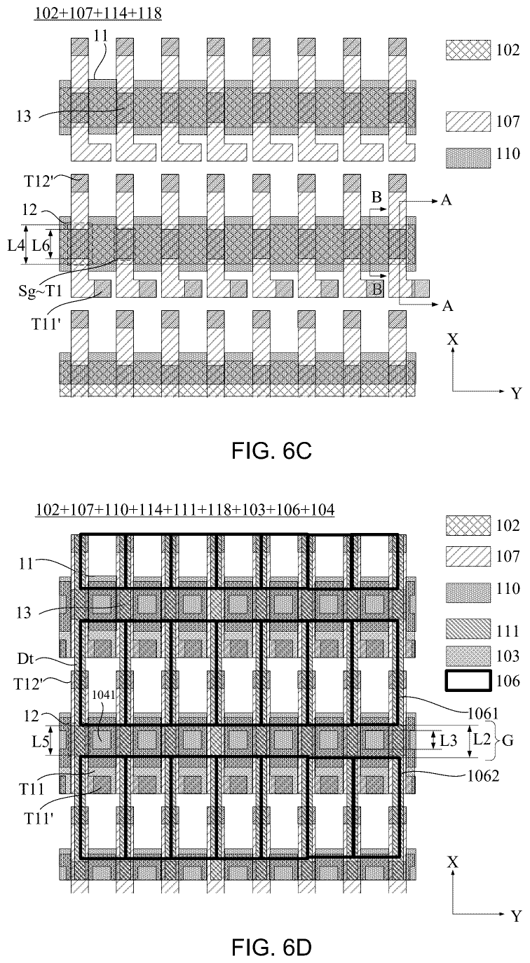

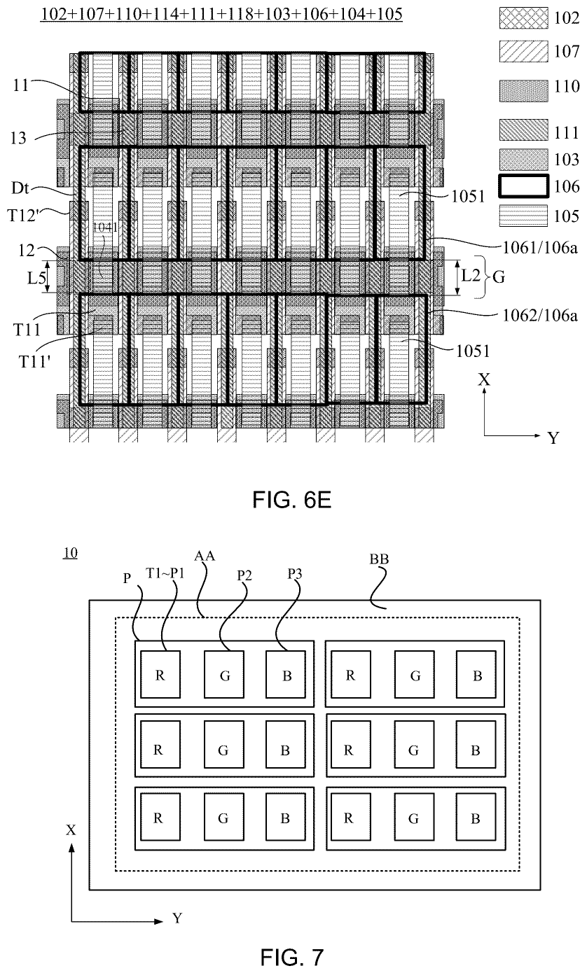

As shown in FIGS. 3J and 4B, the first gate metal layer 102 includes a plurality of first gate lines S1, the first active film layer 107 includes active patterns T13 of a plurality of first transistors, the second gate metal layer 110 includes a plurality of second gate lines S2, the second source-drain metal layer 111 includes a plurality of data lines Dt and source patterns T12 (referring to FIG. 2A) of the first transistors, the color resist layer 106 includes a plurality of color resist blocks 106a, the planarization layer 104 includes a plurality of first via holes 1041, the pixel electrode layer 105 includes a plurality of pixel electrodes 1051, and the common signal line layer 119 includes a plurality of common signal lines 1191 (referring to FIGS. 2A, 4A, 5A and 5B). Referring to FIGS. 3J, 4B and 6E in conjunction with FIGS. 3D and 6C, T12′ represents a source connection pillar connecting the active pattern T13 and the source pattern T12 of the first transistor, and the source connection pillar T12′ penetrates the second gate insulating layer 115 and the second interlayer dielectric layer 114. T11′ represents a drain connection pillar connecting the active pattern T13 and the drain pattern T11 of the first transistor, and the drain connection pillar T11′ penetrates the second gate insulating layer 115, the second interlayer dielectric layer 114, and the interlayer insulating layer 118.

The array substrates mentioned in the following embodiments all conform to the above film layer arrangement, and the film layer structures are specifically introduced below.

In some embodiments, as shown in FIGS. 2A, 4A, 5A and 5B, the array substrate includes a plurality of sub-pixels PX, and a sub-pixel PX includes a first transistor T1 and a pixel electrode 1051. The first transistor T1 is electrically connected to the pixel electrode 1051. The pixel electrode 1051 and a common electrode opposite thereto constitute a capacitor Cst, and the drain pattern T11 of the first transistor T1 is connected to the pixel electrode.

The array substrate 10 includes a base substrate 101, a first gate metal layer 102, a first source-drain metal layer 103, a planarization layer 104 and a pixel electrode layer 105. The first gate metal layer 102 is disposed on a side of the base substrate 101, the first source-drain metal layer 103 is disposed on a side of the first gate metal layer 102 away from the base substrate 101, and the first source-drain metal layer 103 includes a drain pattern T11 of the first transistor T1. The planarization layer 104 is disposed on a side of the first source-drain metal layer 103 away from the base substrate 101, and the planarization layer 104 has a first via hole 1041. As an example, the material of the planarization layer 104 is an organic material, such as a resin. The pixel electrode layer 105 is disposed on a side of the planarization layer 104 away from the base substrate 101, and the pixel electrode layer 105 includes a plurality of pixel electrodes 1051. A pixel electrode and a drain pattern of a first transistor belonging to a same sub-pixel are connected through a first via hole; that is, a sub-pixel PX includes a first transistor T1, a pixel electrode 1051 and a first via hole 1041.

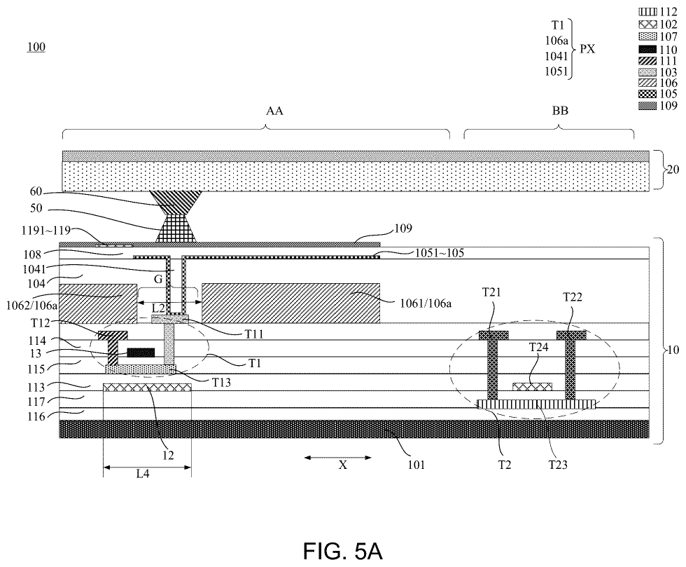

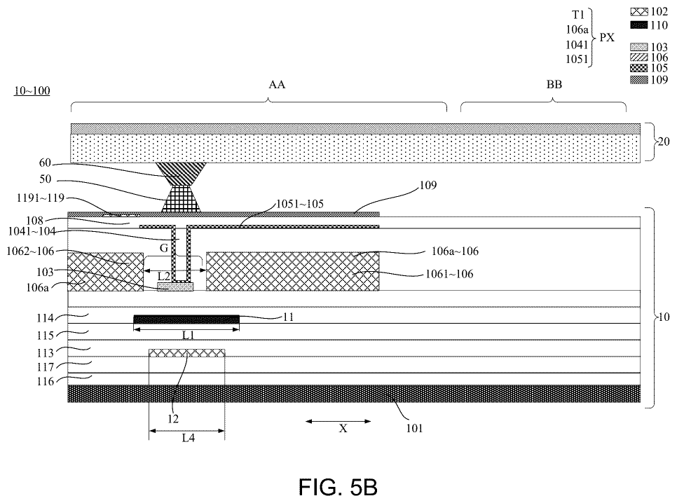

The array substrate 10 further includes a first light-blocking pattern 11. As shown in FIG. 4A, the first light-blocking pattern 11 is located in the common signal line layer 119. As shown in FIG. 2A, the first light-blocking pattern 11 is located in the second gate metal layer 110. As shown in FIG. 5B, the first light-blocking pattern 11 is located in the second gate metal layer 110. The first light-blocking pattern 11 is located on a side of the first gate metal layer 102 away from the base substrate 101; an orthographic projection of the first via hole 1041 on the base substrate 101 is located within an orthographic projection of the first light-blocking pattern 11 on the base substrate 101.

As shown in FIGS. 2A, 4A and 5A, the first transistor T1 is located on a side of the first gate metal layer 102 away from the base substrate. The first transistor T1 includes an active pattern T13, a gate pattern T14, a drain pattern T11 and a source pattern T12. The planarization layer 104 and the pixel electrode layer 105 are sequentially arranged on a side of the first transistor T1 away from the base substrate. The pixel electrode 1051 is connected to the drain pattern T11 of the first transistor T1 through the first via hole 1041. At the position of the first via hole 1041, the liquid crystal arrangement is easily disordered and will result in light leakage; therefore, there is a need to provide a light-blocking structure to block the first via hole to avoid light leakage.

In the array substrate shown in FIG. 1A, the first gate metal layer 102 includes a first gate pattern 12 located in the display area. The first gate pattern 12 serves as a light-blocking bar 1021. The light-blocking bar needs to block the first via hole 1041, so that the dimension of the light-blocking bar 1021 needs to be greater than the dimension of the first via hole. Meanwhile, the light-blocking bar needs to block light for the first transistor, so that the dimension of the light-blocking bar also needs to be greater than the dimension of the active pattern T13 of the first transistor T1. As a result, the dimension L4′ of the light-blocking bar (the first gate pattern) is increased, and the coverage rate of the photoresist becomes high, resulting in a vacuum alarm phenomenon in the subsequent doping process.

For example, as shown in FIG. 1B, FIG. 1B is diagram showing the dimensional relationship between the first via hole 1041 of the planarization layer and the light-blocking bar 1021. To meet the light-blocking requirement, the width of the light-blocking bar 1021 is e+2y+2f, where e is the dimension of the first via hole 1041 at the bottom, and e may be 2.0 μm; e+2y is the dimension of the first via hole 1041 at the top, and e+2y may be 4.0 μm; f is the process fluctuation (including fluctuation of overlay and fluctuation of size) between the light-blocking bar and the planarization layer, and f may be 0.5 μm. After calculation, the dimension L4′ of the light-blocking bar is 5.0 μm, which is relatively large.

Referring to FIGS. 2A, 4A and 5A, in some embodiments of the present disclosure, the orthographic projection of the first via hole 1041 on the base substrate 101 is within the orthographic projection of the first light-blocking pattern 11 on the base substrate 101. That is, the first light-blocking pattern 11 can completely block the first via hole 1041, and the light leakage problem due to liquid crystal disorder at the position of the first via hole 1041 may be avoided, so that the light efficiency of the liquid crystal of the display panel is improved. It will be understood that, the above-mentioned first light-blocking pattern 11 is located on a side of the first gate metal layer 102 away from the base substrate 101; that is, the first light-blocking pattern 11 is not arranged in the first gate metal layer 102, and the first light-blocking pattern 11 may be arranged in the other film layers of the array substrate 10 except the first gate metal layer, which is equivalent to arranging the structure that plays a blocking role in the other film layers except the first gate metal layer 102. In other words, the first gate pattern 12 does not need to block the first via hole. In comparison with the solution of FIG. 1A, in the embodiments of the present disclosure, the dimension of the first gate pattern 12 may be smaller, and resulting in the lower coverage rate of the photoresist used in fabricating the first gate metal layer. In this way, when fabricating the second transistor and using the photoresist mask pattern used in fabricating the first gate metal layer to perform the doping process, it is possible to avoid affecting the vacuum degree of the chamber, thereby avoiding the vacuum alarm phenomenon during the doping process. Therefore, in the array substrate provided by some embodiments of the present disclosure, not only the first via hole is blocked and the light leakage problem is avoided, but also the coverage rate of the photoresist may be reduced to avoid the problem of vacuum alarm during the doping process.

For example, the first gate pattern 12 is located on a side of the first transistor T1 proximate to the base substrate, and the first gate pattern 12 can block light for the first transistor, thereby preventing the characteristics of the first transistor from being changed due to light irradiation. For instance, the first transistor may be a non-photosensitive oxide transistor, which means that when light is irradiated on the surface of the non-photosensitive oxide transistor, the characteristics of the non-photosensitive oxide transistor will not change. In this case, there is no need to provide a light-blocking bar in the first gate metal layer 102; that is, the first gate pattern does not need to play a light-blocking role. Thus, the dimension of the first gate pattern may be further reduced, or even the first gate pattern may be removed to further reduce the coverage rate of the photoresist to further avoid the problem of vacuum alarm during the doping process.

For example, as shown in FIGS. 3B and 6A, the first gate metal layer 102 includes first gate lines S1, and a first gate line S1 overlaps with the active patterns T13 of the first transistors of a row of sub-pixels; the portions of the first gate line S1 overlapping with the active patterns T13 of the first transistors are first gate patterns 12; that is, the first gate line S1 includes multiple first gate patterns.

It will be noted that, the first gate line S1 may transmit a gate scanning signal or transmit no electrical signal. In a case where the first gate line S1 transmits a gate scanning signal, the first gate pattern 12 may serve as a bottom gate pattern of the first transistor.

In a case where the first transistor T1 is a non-photosensitive oxide transistor and the first gate line S1 transmits no electrical signal, the first gate line S1 may not be provided.

It will be noted that, the first transistor in some embodiments of the present disclosure is an oxide thin film transistor, and the oxide thin film transistor has a small off-state current, a strong charge retention capability and good stability.

In some embodiments, referring to FIGS. 2A, 4A, 5A and 5B, a sub-pixel includes a first transistor T1, a pixel electrode 1051, a first via hole 1041 and a color resist block 106a. The array substrate 10 includes a color resist layer 106 disposed between the first source-drain metal layer 103 and the planarization layer 104, and the color resist layer 106 includes a plurality of color resist blocks 106a. Referring to FIGS. 3I, 3J, 4B and 6D, a color resist block 106a and a pixel electrode belonging to a same sub-pixel PX overlap with each other. Color resist blocks 106a of two adjacent sub-pixels in the first direction X have a gap region G therebetween. The first via hole 1041 is located in the gap region G. The first direction is the column direction in which the plurality of sub-pixels are arranged in an array.

For example, the color resist layer 106 includes first color resist blocks 1061 and second color resist blocks 1062. A first color resist block 1061 and a pixel electrode 1051 belonging to a same sub-pixel PX overlap with each other. The first color resist block 1061 and the second color resist block 1062 are adjacent in the first direction X. In the first direction X, the first color resist block 1061 and the second color resist block 1062 have a gap region G therebetween, and the first via hole 1041 is located in the gap region G. As shown in FIG. 2A, a dimension L1 of the first light-blocking pattern 11 in the first direction X is greater than or equal to a dimension L2 of the gap region G in the first direction X; that is, L1>L2.

For example, the color resist layer 106 may include red color resist blocks, green color resist blocks and blue color resist blocks. The first color resist block 1061 may be any one of the red color resist block, the green color resist block and the blue color resist block, and the second color resist block 1062 may be any one of the red color resist block, the green color resist block and the blue color resist block. In the first direction X, the first color resist block 1061 and the second color resist block 1062 may be color resist blocks of a same color or color resist blocks of different colors.

It will be noted that, FIGS. 3A to 3J are each a plan view of the film layers of the array substrate shown in FIG. 2A, FIGS. 4B and 4C are each a plan view of the film layers of the array substrate shown in FIG. 4A, and FIGS. 6A to 6E are each a plan view of the film layers of the array substrate shown in FIG. 5A. Referring to FIGS. 3H and 3I and FIGS. 4B and 6D, the first via hole 1041 is located in the gap region G; that is, the dimension L2, in the first direction X, of the gap region G between the first color resist block 1061 and the second color resist block 1062 is greater than the dimension L3 of the first via hole 1041 in the first direction X.

For example, referring to FIGS. 3H and 3I and FIGS. 4B and 6D, the dimension L1 of the first light-blocking pattern 11 in the first direction X is greater than the dimension L2 of the gap region G in the first direction X. It can be known from the above that the first via hole 1041 is located in the gap region G, and it will be understood that the dimension L1 of the first light-blocking pattern 11 in the first direction X is also greater than the dimension L3 of the first via hole 1041 in the first direction X. In this case, the first light-blocking pattern 11 can block not only the gap region G between the first color resist block 1061 and the second color resist block 1062 but also the first via hole 1041, thereby avoiding poor display problem due to light leakage.

For example, referring to FIG. 4B, the dimension L1 of the first light-blocking pattern 11 in the first direction X is equal to the dimension L2 of the gap region G in the first direction X. It can be known from the above that the first via hole 1041 is located in the gap region G, and it will be understood that the dimension L1 of the first light-blocking pattern 11 in the first direction X is greater than the dimension L3 of the first via hole 1041 in the first direction X. In this case, the first light-blocking pattern 11 can block not only the gap region G between the first color resist block 1061 and the second color resist block 1062 but also the first via hole 1041, thereby avoiding the poor display problem due to light leakage. Thus, in the array substrate provided by some embodiments of the present disclosure, the coverage rate of photoresist may be reduced to avoid the problem of vacuum alarm during the doping process, while the first via hole and the gap between adjacent color resist blocks are ensured to be blocked to avoid the light leakage problem.

In some embodiments, referring to FIGS. 2A, 4A, 5A and 5B, the array substrate 10 further includes a first active film layer 107 located between the first gate metal layer 102 and the first source-drain metal layer 103. The first active film layer 107 includes an active pattern T13 of the first transistor T1. The first gate metal layer 102 includes first gate lines S1, and a first gate line S1 overlaps with active patterns T13 of the first transistors of sub-pixels in a row. The portions of the first gate line S1 overlapping with the active patterns T13 of the first transistors are first gate patterns 12, and the first gate metal layer 102 includes the first gate patterns 12. A first gate pattern 12 overlaps with an active pattern T13 of a first transistor T1. Referring to FIG. 2A, a dimension L4 of the first gate pattern 12 in the first direction X is less than the dimension L1 of the first light-blocking pattern 11 in the first direction X. That is, the dimension of the first gate line S1 in the first direction is less than the dimension of the first light-blocking pattern in the first direction.

It will be understood that, referring to FIG. 3B, the active pattern of the first transistor T1 includes a channel region Sg of the first transistor T1. The first gate pattern 12 overlaps with the active pattern of the first transistor T1, which may mean that an orthographic projection of the first gate pattern 12 on the base substrate 101 overlaps with an orthographic projection of the channel region Sg of the active pattern of the first transistor T1 on the base substrate 101. Alternatively, the first gate pattern 12 overlaps with the active pattern of the first transistor T1, which may mean that the orthographic projection of the channel region Sg of the active pattern of the first transistor T1 on the base substrate 101 is located within the orthographic projection of the first gate pattern 12 on the base substrate 101; that is, the first gate pattern 12 can completely block the channel region Sg of the active pattern of the first transistor T1 to avoid light leakage.

It will be noted that, the first gate pattern 12 is disposed in the first gate metal layer 102, and in such case, the first gate pattern 12 is only used to block the channel region Sg of the first transistor T1. As an example, a dimension of the channel region Sg of the first transistor T1 in the first direction X is 2 μm. Considering process fluctuations, the dimension L4 of the first gate pattern 12 in the first direction X is 3 μm, which may meet the light-blocking requirement. In this case, as shown in FIG. 2A, the dimension L4 of the first gate pattern 12 in the first direction X is less than the dimension L1 of the first light-blocking pattern 11 in the first direction X.

In the case where the first light-blocking pattern 11 and the first gate pattern 12 are both provided, the first transistor T1 may be a photosensitive oxide transistor, and the first gate pattern 12 can block the channel region of the photosensitive oxide transistor to prevent the characteristics of the photosensitive oxide transistor from being changed due to light irradiation. Furthermore, the first light-blocking pattern 11 and the first gate pattern 12 are located in different film layers; in comparison with the solution of the related art in which the first gate pattern disposed in the first gate metal layer blocks the channel region of the first transistor, the first via hole and the gap between adjacent color resist blocks, in this embodiment, the first light-blocking pattern is used to block the first via hole and the gap between adjacent color resist blocks, and the first gate pattern 12 is only used to block the channel region of the first transistor, so that the dimension, in the first direction X, of the first gate pattern 12 located in the first gate metal layer 102 can be reduced. Thus, it is possible to reduce the coverage rate of the photoresist in the fabricating process, thereby avoiding the phenomenon of equipment alarm in the doping process.

Some embodiments regarding the location of the first light-blocking pattern are introduced below.

In some embodiments, the location of the first light-blocking pattern is as follows: referring to FIGS. 4A to 4C, the array substrate 10 further includes a passivation layer 108, a common signal line layer 119 and a common electrode layer 109 that are sequentially arranged on a side of the pixel electrode layer 105 away from the base substrate 101, and the first light-blocking pattern 11 is located in the common signal line layer 119.

For example, as shown in FIG. 4A, the first light-blocking pattern 11 is located on a side of the passivation layer 108 proximate to the common electrode layer 109, and the first light-blocking pattern 11 being located in the common signal line layer 119 can meet the requirement for blocking the first via hole 1041 and the gap region G. Thus, the dimension of the first gate pattern may be reduced, thereby avoiding the phenomenon of equipment alarm in the subsequent doping process.

As shown in FIGS. 4B to 4C, the common signal line layer 119 includes a plurality of first light-blocking lines 1192, and the plurality of first light-blocking lines 1192 extend in a second direction Y. The second direction Y is a row direction in which the plurality of sub-pixels are arranged in an array.

The orthographic projections of first via holes 1041 of a row of sub-pixels on the base substrate are located within an orthographic projection of a first light-blocking line 1192 on the base substrate. The first light-blocking line includes multiple first light-blocking patterns 11.

The common signal line layer 119 includes a plurality of common signal lines 1191, and the plurality of common signal lines 1191 extend in the first direction X. The second source-drain metal layer 111 includes a plurality of data lines Dt, and the plurality of data lines Dt extend in the first direction X. A data line Dt is connected to source patterns of first transistors of a column of sub-pixels, a data line Dt overlaps with a common signal line 1191, and orthographic projections of boundaries of color resist blocks adjacent to a common signal line 1191 on the base substrate are located in an orthographic projection of the common signal line 1191 on the base substrate.

The common signal line 1191 is used to transmit a common voltage signal. The common signal line 1191 is connected to the common electrode layer and is used to transmit a signal to the common electrode layer. The material of the common signal line layer is metal, which has a lower resistance than the material of the common electrode layer (indium tin oxide). The common signal line 1191 is used to transmit the common voltage signal, which is conducive to improving the voltage uniformity of the common electrode layer to improve the signal transmission effect and reduce losses, thereby improving in-plane light uniformity. Furthermore, the common signal line is located between two adjacent columns of color resist blocks, and can block the edges of the color resist blocks to avoid color deviation at a wide viewing angle.

For example, an orthographic projection of a first light-blocking line 1192 on the base substrate is located between orthographic projections of two adjacent rows of color resist blocks on the base substrate, so that the first light-blocking line can block a gap region between the two adjacent rows of color resist blocks and also block the first via holes of a row of sub-pixels. Regarding a certain sub-pixel, the first light-blocking line 1192 includes multiple first light-blocking patterns 11, and a first light-blocking pattern 11 can block not only a gap region G between a first color resist block 1061 (the color resist block of the certain sub-pixel) and a second color resist block 1062 (a color resist block of a sub-pixel adjacent to the certain sub-pixel) but also a first via hole 1041 of the certain sub-pixel to avoid poor display problem due to light leakage.

The plurality of common signal lines 1191 extend in the first direction X. One common signal line 1191 is connected to the plurality of first light-blocking lines 1192, and one first light-blocking line 1192 is connected to the plurality of common signal lines 1191. The plurality of common signal lines and the plurality of first light-blocking lines may be integrally formed, which may be understood as that the width of portions of the common signal lines located in the gap regions G are widened and connected to each other to form the first light-blocking lines 1192, and the width of the remaining portions remain unchanged.

It will be noted that, FIG. 4C shows the stacked structure of the film layers of an array substrate, the difference between the array substrate shown in FIGS. 4A to 4C and the array substrate shown in FIGS. 2A to 3J is that, the width of the second gate line S2 in the second gate metal layer 110 of the array substrate shown in FIGS. 4A to 4C is less than the width of the second gate line S2 in the second gate metal layer 110 of the array substrate shown in FIGS. 2A to 3J, the pattern of the common signal line layer of the array substrate shown in FIGS. 4A to 4C is changed compared to the pattern of the common signal line layer of the array substrate shown in FIGS. 2A to 3J, and the remaining film layers may refer to each other.

It will be noted that, in addition to the function of preventing light leakage, the first light-blocking pattern 11 also has the function of ensuring the in-plane light uniformity of the array substrate 10 because the first light-blocking pattern 11 is connected to the common signal line 1191 and also transmits a common voltage signal, which can reduce production costs to a certain extent.

For example, a material of the first light-blocking pattern is metal.

The dimension of the first light-blocking pattern 11 in the first direction X may be set with reference to the dimension of the light-blocking bar 1021 (the first gate pattern 12) in FIG. 1B; for example, the dimension of the first light-blocking pattern 11 in the first direction X is 5 μm.

In a case where the first light-blocking pattern 11 is located on the side of the passivation layer 108 proximate to the common electrode layer 109, in some embodiments, an orthographic projection of the active pattern of the first transistor T1 on the base substrate 101 is located within an orthographic projection of the first gate pattern 12 on the base substrate 101. That is, an orthographic projection of the channel region of the active pattern of the first transistor on the base substrate is located within an orthographic projection of the first gate line on the base substrate.

It will be understood that, the first gate pattern 12 can completely block the active pattern of the first transistor T1; that is, the first gate pattern 12 can block the channel region Sg of the first transistor T1, so as to prevent the characteristics of the first transistor T1 from being changed due to light irradiation; furthermore, since the first gate pattern 12 in this case is only used to block the channel region Sg of the first transistor T1, the dimension of the first gate pattern 12 may be greatly reduced, for example, from 5 μm in the implementation of FIG. 1A to 3 μm in this embodiment. Therefore, the coverage rate of the photoresist can be reduced in the fabricating process, thereby avoiding the phenomenon of equipment alarm during the doping process.

As shown in FIG. 4A, the gate pattern T14 of the first transistor T1 is located in the second gate metal layer 110. The first gate pattern 12 is used to block the active pattern of the first transistor, and the first gate pattern 12 transmits no electrical signal.

With the design in which the first light-blocking pattern 11 blocks the first via hole 1041 and the gap region G and the first gate pattern 12 blocks the channel region Sg of the first transistor T1, the dimension of the first gate pattern is reduced while the light-blocking requirement is met.

In some other embodiments, the first transistor employs a non-photosensitive oxide transistor, and there is no limitation on the dimensional relationship between the first gate pattern 12 and the active pattern of the first transistor T1, and in such case, the first gate pattern does not need to block light, and the dimension of the first gate pattern 12 may be further reduced, or even the first gate pattern 12 is not provided.

In some other embodiments, the location of the first light-blocking layer is as follows: referring to FIG. 2A and FIGS. 3A to 3J, the array substrate 10 further includes a second gate metal layer 110 disposed between the first active film layer 107 and the first source-drain metal layer 103, and the first light-blocking pattern 11 is located in the second gate metal layer 110. An embodiment in which the first light-blocking pattern 11 is located in the second gate metal layer 110 is introduced below.

For example, referring to FIG. 2A, the first light-blocking pattern 11 is located in the second gate metal layer 110 and is located on a side of the active pattern T13 of the first transistor T1 away from the base substrate. The first light-blocking pattern 11 can meet the requirements for blocking the first via hole 1041 and the gap region G, so that the dimension of the first gate pattern 12 is reduced. In addition, the second gate metal layer 110 is located on a side of the pixel electrode layer 105 proximate to the base substrate 101, so the electric field generated by the second gate metal layer 110 will be shielded by the electric field of the pixel electrode layer 105, and accordingly, the electric field generated by the second gate metal layer 110 will not affect the electric field distribution between the pixel electrode layer 105 and the common electrode layer 109, and thus will not affect the light efficiency of liquid crystal of the display panel. As a result, the display effect is improved.

Referring to FIG. 2B, FIG. 2B is a diagram showing the dimensional relationship between the first via hole 1041 of the planarization layer 104 and the first light-blocking pattern located in the second gate metal layer 110. As an example, the dimension e of the first via hole 1041 at the bottom is, for example, 2 μm, and the dimension g=e+2y of the first via hole 1041 at the top is, for example, 4 μm. In this case, the dimension L1 of the first light-blocking pattern 11 in the first direction X is L1=e+2y+2f, where f is the process fluctuation, which means that L1 is at least 5 μm to meet the light-blocking requirement. The first light-blocking pattern 11 shown in FIG. 2B is schematic to illustrate the dimensional relationship with the first via hole 1041 in the first direction X, and does not represent the specific location of the first light-blocking pattern 11.

In some embodiments, referring to FIGS. 2A and 3G, the second gate metal layer 110 includes second gate lines S2, and a second gate line S2 overlaps with active patterns T13 of the first transistors T1 of a row of sub-pixels. For a sub-pixel, the active pattern T13 of the first transistor overlaps with the first via hole 1041, and the first light-blocking pattern 11 is a portion of the second gate line S2 overlapping with the active pattern T13 of the first transistor.

The first gate metal layer 102 includes first gate lines S1. A portion (the first gate pattern 12) of a first gate line S1 overlapping with the active pattern T13 of the first transistor serves as the gate pattern of the first transistor. The first gate pattern 12 serves as the gate pattern T14 of the first transistor T1, and an orthographic projection of the first gate pattern 12 on the base substrate 101 is located within an orthographic projection of the active pattern of the first transistor T1 on the base substrate 101. In this case, the first transistor T1 is a bottom-gate transistor.

For example, as shown in FIGS. 2A and 3B, the first gate pattern 12 only serves as the gate pattern of the first transistor T1 and is not used to block the active pattern T13 of the first transistor T1. In this case, for example, the dimension of the channel region Sg of the first transistor T1 in the first direction X is 2 μm. Since the gate of the first transistor T1 overlaps with the channel region Sg, the dimension of the first gate pattern 12 in the first direction X needs to be at least 2 μm. With such arrangement of the first gate pattern 12, the coverage rate of the photoresist used in the fabricating process may be further reduced, thereby avoiding the phenomenon of equipment alarm during the doping process.

It will be noted that, in the case where the first gate pattern 12 serves as the gate pattern of the first transistor T1, the first transistor T1 may be a non-photosensitive oxide transistor to avoid the bad effects on the display of the display panel caused by a fact that the characteristics of the first transistor T1 is affected by light irradiation.

FIGS. 3C to 3I are each a plan view showing the stacked structure according to FIG. 2B. In some embodiments, as shown in FIGS. 3C to 3I, the first light-blocking patterns 11 shown in FIGS. 3C to 3I are all located in the second gate metal layer 110. Referring to FIG. 3E, the array substrate 10 further includes a first interlayer dielectric layer 113 and a second interlayer dielectric layer 114; the first interlayer dielectric layer 113 is disposed between the first gate metal layer 102 and the first active film layer 107, and the second interlayer dielectric layer 114 is disposed between the second gate metal layer 110 and the first source-drain metal layer 103. As an example, the materials of the first interlayer dielectric layer 113 and the second interlayer dielectric layer 114 may be any one of silicon nitride, silicon oxide or silicon oxynitride, or a combination of any two of these materials.

In some embodiments, the second gate line S2 is electrically connected to the first gate line S1 in the peripheral area BB. For example, the second gate line S2 is electrically connected to the first gate line S1 through a via hole penetrating the first interlayer dielectric layer 113 and the second gate insulating layer 115, and a portion of the second gate line S2 overlapping with the active pattern T13 of the first transistor serves as the top gate pattern of the first transistor.

That is, the first light-blocking pattern 11 overlaps with the active pattern of the first transistor, and the first light-blocking pattern 11 is electrically connected to the first gate pattern 12 in the peripheral area BB.

For example, the first light-blocking pattern 11 is electrically connected to the first gate pattern 12 in the peripheral area BB through a via hole. For instance, the first interlayer dielectric layer 113 and the second gate insulating layer 115 are sequentially arranged between the first gate metal layer 102 and the second gate metal layer 110, and the first interlayer dielectric layer 113 is disposed proximate to the first gate metal layer 102, and this via hole is a via hole in the first interlayer dielectric layer 113 and the second gate insulating layer 115. With the above electrical connection arrangement, the second gate line S2 and the first gate line S1 transmit a scanning signal synchronously; that is, the first light-blocking pattern 11 and the first gate pattern transmit the scanning signal synchronously. The first light-blocking pattern 11 is located on a side of the active pattern of the first transistor T1 away from the base substrate and overlaps with the active pattern of the first transistor T1. The first light-blocking pattern may serve as the top gate pattern of the first transistor, and the first gate pattern may serve as the bottom gate pattern of the first transistor, so that the first transistor T1 changes from a bottom gate structure to a top-bottom gate structure, which allows the first transistor T1 to have good transmission stability to improve the reliability of the display panel.

Another embodiment in which the first light-blocking pattern 11 is located in the second gate metal layer 110 is introduced below. As shown in FIGS. 5A and 5B, FIGS. 5A and 5B are sectional views of an array substrate of the same structure at different positions. As shown in FIGS. 6A to 6E, FIGS. 6A to 6E are each a plan view showing the film layers of the array substrate shown in FIGS. 5A and 5B. FIG. 5A is a sectional view along the line AA in FIG. 6C, and FIG. 5B is a sectional view along the line BB in FIG. 6C.

In some implementations, referring to FIGS. 6A to 6E, the second gate metal layer 110 includes second gate lines S2, and a second gate line S2 overlaps with active patterns T13 of the first transistors of a row of sub-pixels. The second gate line S2 includes a first light-blocking pattern 11 and a second gate pattern 13 connected to each other. The second gate pattern 13 overlaps with the active pattern of a first transistor and serves as the gate pattern of the first transistor. The first light-blocking pattern 11 is non-overlapping with the active pattern of the first transistor.

The first light-blocking patterns 11 are located in the second gate metal layer 110, and the first light-blocking pattern 11 is non-overlapping with the active pattern T13 of the first transistor. The second gate metal layer 110 further includes second gate patterns 13, and a second gate pattern overlaps with an active pattern T13 of a first transistor. The second gate pattern 13 serves as the gate pattern of the first transistor T1, and the second gate pattern 13 is connected to a first light-blocking pattern 11.

It will be understood that, the second gate pattern 13 only serves as the gate of the first transistor T1 and is not used to block the channel region Sg of the first transistor T1. In this case, the dimension of the channel region Sg of the first transistor T1 in the first direction X is, for example, 2 μm. Since the gate of the first transistor T1 overlaps with the channel region Sg, the dimension L5 of the second gate pattern 13 in the first direction X needs to be at least 2 μm.

For example, referring to FIG. 6B, the second gate pattern 13 and the first light-blocking pattern 11 are connected in the second direction Y. The second direction Y is perpendicular to the first direction X. The dimension L1 of the first light-blocking pattern 11 in the first direction X is the width described above. It can be seen from FIG. 6B that the dimension L1 of the first light-blocking pattern 11 in the first direction X is greater than the dimension L5 of the second gate pattern 13 in the first direction X.

In some examples, as shown in FIG. 6B, the first light-blocking patterns 11 and the second gate patterns 13 are arranged in the second direction Y and are sequentially connected. In a plane parallel to the base substrate 101, the first direction X is perpendicular to the second direction Y.

As shown in FIGS. 6A to 6C, the first gate metal layer 102 includes a plurality of first gate lines S1, and a plurality of second gate lines S2 are disposed in the second gate metal layer 110. The plurality of second gate lines S2 all extend in the second direction Y. A first gate line passes through active patterns T13 of a row of first transistors, and a second gate line passes through active patterns T13 of a row of first transistors. A first gate line overlaps with a second gate line, and the second gate line S2 includes multiple first light-blocking patterns 11 and multiple second gate patterns 13 that are alternately arranged.

It will be noted that, in the case where the first transistor T1 is a photosensitive oxide transistor, in addition to the first light-blocking patterns 11 and the second gate patterns 13, the array substrate 10 further includes first gate patterns 12 disposed in the first gate metal layer 102. In this case, the first gate pattern 12 can play the role of blocking the channel region of the first transistor T1. The provision of the first gate pattern 12 can prevent the signal transmission of the display panel from being affected caused by the change in the characteristics of the first transistor T1 due to light irradiation. According to the above description, the dimension of the first gate pattern 12 may be 3 μm. In comparison with the arrangement in which the light-blocking structure is completely disposed in the first gate metal layer 102 in the related art, in the embodiments of the present disclosure, the dimension L4 of the first gate pattern 12 in the first gate metal layer 102 in the first direction X is greatly reduced, which can further reduce the coverage rate of the photoresist used in the fabricating process to avoid the phenomenon of equipment alarm during the doping process. In the case where the first transistor T1 is a non-photosensitive oxide transistor, the second gate patterns 13 may not be provided in the array substrate 10; the characteristics of the non-photosensitive oxide transistor will not be affected by light, so that the phenomenon of equipment alarm during the doping process may be avoided.

In some embodiments, referring to FIGS. 5B and 6C, the orthographic projection of the active pattern of the first transistor T1 on the base substrate 101 in located within the orthographic projection of first gate pattern 12 on the base substrate 101.

For example, referring to FIGS. 5B and 6C, the orthographic projection of the active pattern of the first transistor T1 on the base substrate 101 is located within the orthographic projection of the first gate pattern 12 on the base substrate 101; that is, the first gate pattern 12 has the function of blocking the channel region of the first transistor T1. In this case, the first transistor T1 is a photosensitive oxide transistor, and the dimension L4 of the first gate pattern 12 in the first direction X is greater than the dimension L6 of the active pattern T13 of the first transistor T1 in the first direction X. As shown in FIG. 6C, the active pattern of the first transistor T1 is located in the first active film layer 107, and the orthographic projection of the active pattern of the first transistor T1 on the base substrate 101 is located within the orthographic projection of the first gate pattern 12 on the base substrate 101.

In some embodiments, as shown in FIG. 6D, the array substrate 10 further includes a second source-drain metal layer 111 disposed between the first source-drain metal layer 103 and the second gate metal layer 110. The second source-drain metal layer 111 includes data lines Dt, the data lines Dt extend in the first direction X, and an orthographic projection of a data line Dt on the base substrate 101 overlaps with an orthographic projection of a second gate pattern 13 on the base substrate 101. The first direction X is perpendicular to a direction in which the second gate patterns 13 and the first light-blocking patterns 11 are arranged.

For example, referring to FIG. 6D, the data lines Dt are located in the second source-drain metal layer 111, and the data lines Dt extend in the first direction X. It can be seen from FIG. 6D that, an orthographic projection of a gap region G between a first color resist block 1061 and a second color resist block 1062 on the base substrate 101 partially overlaps with an orthographic projection of a second gate pattern 13 on the base substrate 101, and the second gate pattern 13 has the function of blocking the gap region G to prevent light leakage. The dimension L5 of the second gate pattern 13 in the first direction X is less than or equal to the dimension L2 of the gap region G in the first direction X. Referring to FIG. 6D, in the case where the dimension L5 of the second gate pattern 13 in the first direction X is equal to the dimension L2 of the gap region G in the first direction X, the second gate pattern 13 can be used to block the edge of the gap region G to prevent light leakage. Referring to FIG. 6E, in the case where the dimension L5 of the second gate pattern 13 in the first direction X is less than the dimension L2 of the gap region G in the first direction X, since the orthographic projection of the data line Dt on the base substrate 101 overlaps with the orthographic projection of the second gate pattern 13 on the base substrate 101, the data line Dt can block a region in the gap region G that is not blocked by the second gate pattern 13, so as to realize a secondary blocking and thus avoid light leakage.

In some embodiments, referring to FIGS. 2A, 4A, 5A and 5B, the array substrate 10 further includes a second transistor T2 disposed in the peripheral area BB. The gate pattern of the second transistor T2 is located in the first gate metal layer 102. The second active film layer 112 includes an active pattern T23 of the second transistor T2; the first gate metal layer 102 includes a gate pattern T24 of the second transistor T2, and the second source-drain metal layer 111 includes a source pattern T21 and a drain pattern T22 of the second transistor T2, and the source pattern T12 of the first transistor T1. The second transistor T2 is a top-gate transistor.

For example, referring to FIG. 2A, the second transistor T2 is disposed in the peripheral area BB of the array substrate 10. The second transistor T2 is a low-temperature polycrystalline silicon transistor, and correspondingly, the material of the second active film layer 112 disposed between the base substrate 101 and the first gate metal layer 102 is a low-temperature polycrystalline silicon material.

In some embodiments, referring to FIG. 7, the array substrate 10 includes a plurality of pixel regions P, and each pixel region P includes at least a red sub-pixel region P1, a green sub-pixel region P2, and a blue sub-pixel region P3. For example, the three sub-pixels may be arranged in a shape of a stripe, a triangle or a diagonal. FIG. 7 illustrates an example in which the three sub-pixels are arranged in a shape of a stripe. In the second direction Y, the red sub-pixel regions P1, the green sub-pixel regions P2, and the blue sub-pixel regions P3 are periodically arranged as a whole. In the first direction X, the red sub-pixel regions P1, the green sub-pixel regions P2, and the blue sub-pixel regions P3 are individually arranged in columns. Each sub-pixel region is provided with a first transistor T1, a color resist block and a common electrode.

For example, referring to FIG. 6E, in the first direction X, two adjacent red sub-pixel regions P1 respectively include a first color resist block 1061 and a second color resist block 1062, and orthographic projections of the first color resist block 1061 and the second color resist block 1062 on the base substrate 101 both overlap with an orthographic projections of a same data line Dt extending in the first direction X on the base substrate 101. That is, the sub-pixels in a column of sub-pixel regions are connected to a data line Dt, and the active patterns of the plurality of first transistors T1 included in the plurality of pixel region P are arranged in an array. Referring to FIGS. 6B and 6D, orthographic projections of active patterns of the first transistors T1 on the base substrate 101 overlap with an orthographic projections of a data line Dt on the base substrate 101; therefore, the active patterns of the first transistors T1 are connected to the data line Dt through the source patterns of the first transistors T1.

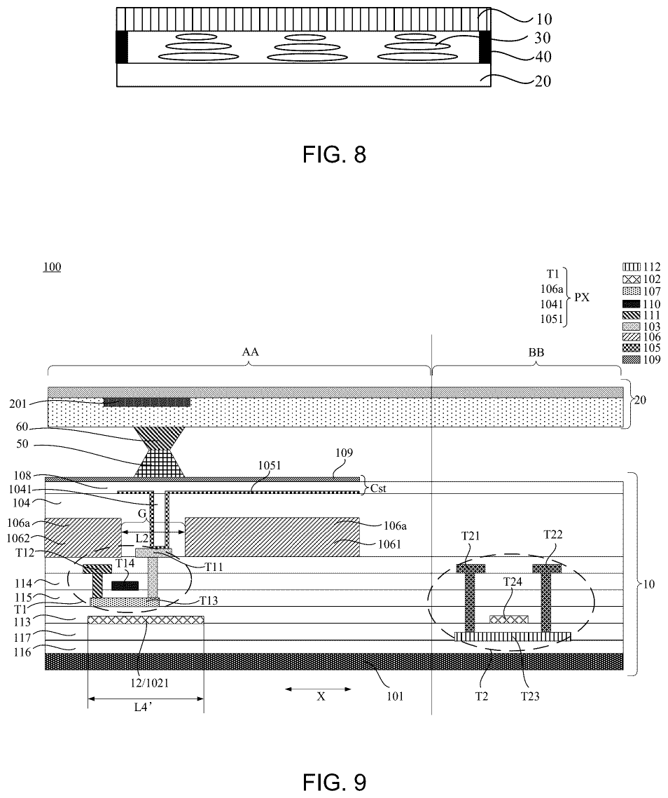

Referring to FIG. 8, embodiments of the present disclosure provide a display panel 100. The display panel 100 includes the array substrate 10 as provided in any of the above embodiments, an opposite substrate 20 disposed opposite to the array substrate 10 and a liquid crystal layer 30 disposed between the array substrate 10 and the opposite substrate 20. Therefore, the display panel 100 provided in some embodiments of the present disclosure has all the beneficial effects achieved by the array substrate 10 provided in any of the above embodiments, which will not be repeated here.

For example, as shown in FIG. 8, the array substrate 10 and the opposite substrate 20 may be bonded together by a frame sealant 40, so as to confine the liquid crystal layer 30 in a region enclosed by the frame sealant 40.

In some embodiments, as shown in FIGS. 2A, 4A, 5A, 5B and 9, the display panel 100 further includes a first boss 50 and a second boss 60 that are disposed between the array substrate 10 and the opposite substrate 20. The first boss 50 is disposed closer to the array substrate 10 than the second boss 60, and the first boss 50 and the second boss 60 are arranged opposite to each other. An orthographic projection of the first boss 50 on the base substrate 101 is located within the orthographic projection of the first light-blocking pattern 11 on the base substrate 101.

For example, in order to ensure that the display panel 100 can maintain a certain cell gap in case of being subjected to an external force and pressed, the first boss 50 and the second boss 60, also referred to as photo spacers (PS), are disposed between the array substrate 10 and the opposite substrate 20. The first boss 50 and the second boss 60 have a certain supporting function. Since the liquid crystal arrangement is disordered at the position of the first boss 50, light leakage easily occurs. With the above arrangement, the orthographic projection of the first boss 50 on the base substrate 101 is located within the orthographic projection of the first light-blocking pattern 11 on the base substrate 101, and the first light-blocking pattern 11 has a light-blocking function, which can prevent the display of the display panel from being affect due to the problem of light leakage at the position of the first boss 50.

In some embodiments, as shown in FIG. 9, the opposite substrate 20 further includes a black matrix light-blocking pattern 201, and the orthographic projection of the first light-blocking pattern 11 on the base substrate 101 is located within an orthographic projection of the black matrix light-blocking pattern 201 on the base substrate 101.

For example, referring to FIG. 9, the provision of the black matrix light-blocking pattern 201 is mainly to block the first via hole 1041 and the gap region G between the first color resist block 1061 and the second color resist block 1062, so as to avoid light interference and light leakage, and ensure the in-plane uniformity of the array substrate 10. According to the above description, the dimension L1 of the first light-blocking pattern 11 in the first direction X is, for example, 5 μm, and in a case where the first light-blocking pattern 11 is not provided, the black matrix light-blocking pattern 201 is used to replace the first light-blocking pattern 11. However, since the black matrix light-blocking pattern 201 is located in the opposite substrate 20, there is a need to take the alignment accuracy between the array substrate 10 and the opposite substrate 20 into consideration, the alignment accuracy is, for example, 1.5 μm, which means that the dimension of the black matrix light-blocking pattern 201 in the first direction X needs to be 7 μm to meet the above light-blocking requirement. Therefore, the orthographic projection of the first light-blocking pattern 11 on the base substrate 101 is located within the orthographic projection of the black matrix light-blocking pattern 201 on the base substrate 101.

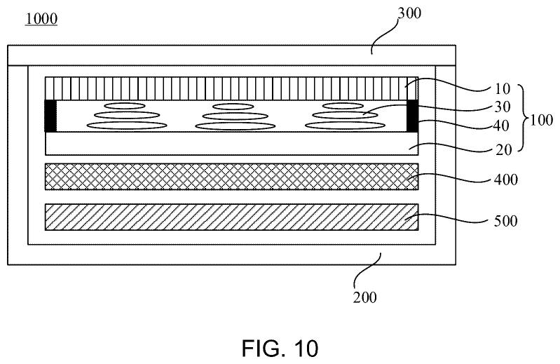

As shown in FIG. 10, some embodiments of the present disclosure provide a display apparatus 1000, and the display apparatus may be a mobile phone, a tablet computer, a personal digital assistant (PDA), a vehicle-mounted computer, a wearable display apparatus, etc. The embodiments of the present disclosure do not particularly limit the specific form of the display apparatus. As shown in FIG. 10, the display apparatus 1000 includes the display panel 100 provided in any of the above embodiments. Therefore, the display apparatus 1000 provided in some embodiments of the present disclosure has all the beneficial effects achieved by the display panel 100 provided in any of the above embodiments, which will not be repeated here.

For example, as shown in FIG. 10, the display apparatus 1000 in the embodiments of the present disclosure is exemplified by a liquid crystal display apparatus. Referring to FIG. 10, in some embodiments, the main structure of the liquid crystal display apparatus 1000 includes a frame 200, a cover plate 300, the display panel 100, a backlight module 400, a circuit board 500 and other electronic components.

The frame 200 encloses an accommodating space, and the display panel 100, the backlight module 400, the circuit board 500 and other electronic components are disposed in the accommodating space. The cover plate 300 is disposed on the open side of the frame 200. The display panel 100 is disposed closer to the cover plate 300 than the backlight module 400 and the circuit board 500. The circuit board 500 is disposed further away from the cover plate 300 than the display panel 100 and the backlight module 400. The backlight module 400 is disposed between the display panel 100 and the circuit board 500.

As shown in FIG. 10, some embodiments of the present disclosure provide a display apparatus. The display apparatus provided in the embodiments of the present disclosure may be any apparatus that displays images whether in motion (e.g., a video) or stationary (e.g., static images), and whether textual or graphical. More specifically, it is expected that the embodiments may be implemented in or associated with a variety of electronic devices, which may include (but are not limit to), for example, mobile phones, wireless devices, personal digital assistants (PDAs), hand-held or portable computers, GPS receivers/navigators, cameras, MP4 video players, video cameras, game consoles, watches, clocks, calculators, TV monitors, flat panel displays, computer monitors, car displays (e.g., odometer displays), navigators, cockpit controllers and/or displays, camera view displays (e.g., rear view camera displays in vehicles), electronic photos, electronic billboards or indicators, projectors, building structures, packagings and aesthetic structures (e.g., a display for an image of a piece of jewelry), etc.

The above descriptions are merely specific implementations of the present disclosure, but the protection scope of the present disclosure is not limited thereto, and variations or substitutions that any person skilled in the art could conceive of within the technical scope of the present disclosure should all fall within the protection scope of the present disclosure. Therefore, the protection scope of the present disclosure should be subject to the protection scope of the claims.

1. An array substrate, having a display area and a peripheral area disposed on a periphery of the display area, wherein the array substrate comprises a plurality of sub-pixels located in the display area, each sub-pixel of the plurality of sub-pixels including a first transistor and a pixel electrode; and
the array substrate comprises:
a base substrate;
a first gate metal layer disposed on a side of the base substrate;
a first source-drain metal layer disposed on a side of the first gate metal layer away from the base substrate, wherein the first source-drain metal layer includes a drain pattern of the first transistor;
a planarization layer disposed on a side of the first source-drain metal layer away from the base substrate, wherein the planarization layer has first via holes; and
a pixel electrode layer disposed on a side of the planarization layer away from the base substrate, wherein the pixel electrode layer includes a plurality of pixel electrodes, and a pixel electrode and a drain pattern of a first transistor belonging to a same sub-pixel are connected through a first via hole of the first via holes; and
the array substrate further comprises first light-blocking patterns located on a side of the first gate metal layer away from the base substrate; wherein
an orthographic projection of the first via hole on the base substrate is located within an orthographic projection of a first light-blocking pattern of the first light-blocking patterns the base substrate.

2. The array substrate according to claim 1, wherein the sub-pixel further includes a color resist block, and the array substrate further comprises:
a color resist layer disposed between the first source-drain metal layer and the planarization layer, wherein the color resist layer includes a plurality of color resist blocks, and a color resist block and the pixel electrode belonging to the same sub-pixel overlap; color resist blocks of two adjacent sub-pixels in a first direction have a gap region therebetween; the first via hole is located in the gap region; the first direction is a column direction in which the plurality of sub-pixels are arranged in an array;
wherein a dimension of the first light-blocking pattern in the first direction is greater than or equal to a dimension of the gap region in the first direction.

3. The array substrate according to claim 2, wherein
the array substrate further comprises a first active film layer disposed between the first gate metal layer and the first source-drain metal layer, wherein the first active film layer includes an active pattern of the first transistor included in each sub-pixel;
the first gate metal layer includes first gate lines, and a first gate line overlaps with active patterns of first transistors of a row of sub-pixels; and
a dimension of the first gate line in the first direction is less than the dimension of the first light-blocking pattern in the first direction.

4. The array substrate according to claim 1, wherein the array substrate further comprises a passivation layer, a common signal line layer and a common electrode layer that are sequentially arranged on a side of the pixel electrode layer away from the base substrate, and the first light-blocking patterns are located in the common signal line layer.

5. The array substrate according to claim 4, wherein the common signal line layer includes a plurality of first light-blocking lines extending in a second direction; the second direction is a row direction in which the plurality of sub-pixels are arranged in an array;
orthographic projections of first via holes of a row of sub-pixels on the base substrate are located within an orthographic projection of a first light-blocking line of the plurality of first light-blocking lines on the base substrate; and
the first light-blocking line includes multiple first light-blocking patterns.

6. The array substrate according to claim 4, wherein the first gate metal layer includes first gate lines, and an orthographic projection of a channel region of an active pattern of the first transistor on the base substrate is located within an orthographic projection of a first gate line on the base substrate.

7. The array substrate according to claim 1, wherein the array substrate further comprises a first active film layer disposed between the first gate metal layer and the first source-drain metal layer, and a second gate metal layer disposed between the first active film layer and the first source-drain metal layer; the first light-blocking patterns being located in the second gate metal layer.

8. The array substrate according to claim 7, wherein the second gate metal layer includes second gate lines, and a second gate line overlaps with active patterns of first transistors of a row of sub-pixels; and
in the sub-pixel, an active pattern of the first transistor overlaps with the first via hole, and the first light-blocking pattern is a portion of the second gate line overlapping with the active pattern of the first transistor.

9. The array substrate according to claim 8, wherein the first gate metal layer includes first gate lines, and a portion of a first gate line overlapping with the active pattern of the first transistor serves as a gate pattern of the first transistor.

10. The array substrate according to claim 9, wherein the second gate line and the first gate line are electrically connected in the peripheral area, and a portion of the second gate line overlapping with the active pattern of the first transistor serves as a top gate pattern of the first transistor.

11. The array substrate according to claim 7, wherein the second gate metal layer includes second gate lines, and a second gate line overlaps with active patterns of first transistors of a row of sub-pixels;
the second gate line includes a first light-blocking pattern and a second gate pattern that are connected, the second gate pattern overlaps with an active pattern of the first transistor, and the second gate pattern serves as a gate pattern of the first transistor; and
the first light-blocking pattern is non-overlapping with the active pattern of the first transistor.

12. The array substrate according to claim 11, wherein the array substrate further comprises a second source-drain metal layer disposed between the first source-drain metal layer and the second gate metal layer; the second source-drain metal layer includes data lines extending in a first direction, and an orthographic projection of a data line on the base substrate overlaps with an orthographic projection of the second gate pattern on the base substrate;
wherein the first direction is a column direction in which the plurality of sub-pixels are arranged.

13. The array substrate according to claim 1, wherein the array substrate further comprises a second transistor disposed in the peripheral area, and a gate pattern of the second transistor is located in the first gate metal layer; and
the array substrate further comprises:
a second active film layer disposed between the base substrate and the first gate metal layer, wherein the second active film layer includes an active pattern of the second transistor; and
a second source-drain metal layer disposed on a side of the first source-drain metal layer proximate to the base substrate, wherein the second source-drain metal layer includes a source pattern and a drain pattern of the second transistor and a source pattern of the first transistor.

14. The display panel, comprising:
the array substrate according to claim 1;
an opposite substrate arranged opposite to the array substrate; and
a liquid crystal layer located between the array substrate and the opposite substrate.

15. The display panel according to claim 14, wherein the display panel further comprises a first boss and a second boss that are disposed between the array substrate and the opposite substrate; wherein the first boss is disposed closer to the array substrate than the second boss, and the first boss and the second boss are arranged opposite to each other; and
an orthographic projection of the first boss on the base substrate is located within the orthographic projection of the first light-blocking pattern on the base substrate.

16. The display panel according to claim 14, wherein the opposite substrate includes a black matrix light-blocking pattern, and the orthographic projection of the first light-blocking pattern on the base substrate is located within an orthographic projection of the black matrix light-blocking pattern on the base substrate.

17. A display apparatus, comprising:
the display panel according to claim 14; and
a backlight module stacked with the display panel.

18. The array substrate according to claim 4, wherein the common signal line layer includes a plurality of common signal lines extending in a first direction; the array substrate further comprises a color resist layer disposed between the first source-drain metal layer and the planarization layer, the color resist layer includes a plurality of color resist blocks, and orthographic projections of boundaries of two columns of color resist blocks adjacent to a common signal line on the base substrate are located in an orthographic projection of the common signal line on the base substrate.

19. The array substrate according to claim 4, wherein the common signal line layer includes a plurality of common signal lines connected to the common electrode layer and configured to transmit a common voltage signal to the common electrode layer.

20. The array substrate according to claim 5, wherein the array substrate further comprises a color resist layer disposed between the first source-drain metal layer and the planarization layer, the color resist layer includes a plurality of color resist blocks, and the orthographic projection of the first light-blocking line on the base substrate is located between orthographic projections of two adjacent rows of color resist blocks on the base substrate.
